(19) United States
(12) Patent Application Publication
(10) Pub. No.: US 2004/0184623 A1
(43) Pub. Date: Sep. 23, 2004

(54) Speaker unit with active leak compensation

(76) Inventors: Leif Johannsen, Odder (DK); Morten Kjeldsen Andersen, Odder (DK)

Correspondence Address: HARNESS, DICKEY & PIERCE, P.L.C., P.O. BOX 8910, RESTON, VA, 20195, US

(21) Appl. No.: 10/793,010

(22) Filed: Mar. 5, 2004

Related U.S. Application Data
(60) Provisional application No. 60/452,538, filed on Mar. 7, 2003.

(51) Int. Cl. H04R 1/00; H04R 9/06; H04R 3/00

(52) U.S. Cl. 381/117; 381/396; 381/423

(57) ABSTRACT

The present invention relates to an electro dynamic speaker unit comprising an electro dynamic motor adapted for receiving a first electrical signal and to drive a diaphragm in accordance with the received first electrical signal. The speaker unit further comprises sensing means adapted for generating a second electrical signal in accordance with a movement of the diaphragm, and determining means adapted for receiving the first and the second electrical signals so as to determine an acoustical load of the speaker unit from the first and the second electrical signals. The determining means further generates a third electrical signal in accordance with the determined acoustical load of the speaker unit. The present invention further relates to a method for active leak compensation of an electro dynamic speaker unit.

### FIELD OF THE INVENTION

The present invention relates to an electro dynamic speaker, and more particularly, to a speaker unit especially suited for use within miniature equipment such as for equipment within telecommunication. The speaker unit comprises means for actively making the speaker unit insensitive to the acoustical load, thus rendering the speaker unit leak tolerant. Another aspect of the invention relates to a method for obtaining a leak tolerant sound reproduction from a telecommunication handset.

### BACKGROUND OF THE INVENTION

The problem of leak intolerant telephone speaker units is well known from earlier telephone handsets: they provided an adequate low frequency response as long as the speaker area of the handset was pressed against the listener's outer ear. However, only a small leak between the handset and the listener's ear resulted in a dramatic drop of the low frequency response, thus reducing the perceived sound quality of such a handset badly.

The reason for this leak intolerant low frequency response of the speaker relates to the fact that even a small leak between handset and the ear results in a large difference in the acoustical load of the speaker. With the handset pressed against the ear the speaker plays into a small air volume, whereas holding the handset only a few mm from the outer ear, the speaker will approximately play into free field—an infinitely large air volume. Earlier, the frequency response of the speaker was optimised for measurement in a coupler with the handset mounted sealed to a coupler with a specified air volume. This could be achieved with a speaker having a high acoustical output impedance, however such speakers were very sensitive to an acoustical load being different from—such as caused by a small leak between the handset and the ear.

Until recently, this leak intolerant behaviour has been solved acoustically—both within stationary telephones and within mobile telecommunication equipment. This is typically implemented with a load hole positioned close to the speaker unit. In a sealed condition, this hole will connect the inner air volume of the mobile phone and the ear. Therefore, the acoustical output of such a handset will be generally tolerant to leaks between the handset and the outer ear of the listener since it will exhibit a low acoustical output impedance. In order for this solution to work properly, a certain minimum inner air volume of the mobile phone or handset is required. With the latest miniature mobile phones there is not enough free air volume in the phone to make the principle work satisfactory. Therefore, there is a need for another method of providing the leak tolerance in such miniature phones.

Several loudspeaker systems are described, wherein sensing the movement of the speaker diaphragm, typically by means of an accelerometer, is used for controlling an acoustical output of the speaker so as to electrically correct any linear or non-linear distortion. Normally, such systems are called Motional Feed-back (MFB) systems, and they are most often intended for use within hi-fi sound reproduction.

WO 00/21331 describes a loudspeaker system being adaptable to the environment. By means of a microphone movable between two positions in front of the diaphragm, the diaphragm velocity and produced sound pressure is determined when a test signal is applied to the loudspeaker. In this way the radiation resistance of the diaphragm is extracted. The radiation resistance reflects the acoustical influence from the environments on the loudspeaker. Any change in the radiation resistance will result in an according change in acoustic output. With the determined radiation resistance it is possible to compensate for such a change by means of a filter in the electrical reproduction chain. Hereby, it is possible to adapt the acoustic output of the loudspeaker to the environments.

The solution described in WO 00/21331 is intended for use in hi-fi loudspeakers in order to obtain a flat frequency response at low frequencies independent of the room and the position in which the loudspeaker is placed.

Even though WO 00/21331 describes a loudspeaker with a frequency response being adaptable according to changes in the acoustical environment, it is not possible to adapt the loudspeaker proposed in WO 00/21331 within miniature telecommunication equipment. The loudspeaker system described in WP 00/21331 is by nature bulky, since a microphone arrangement is required in front of the diaphragm. This will be unacceptable for miniature equipment such as mobile phones. Within hi-fi speakers the size of such an arrangement is not an issue.

In addition, for the system described in WO 00/22331 to work, it is necessary to play an audible test signal for a period of time where the system performs the necessary measurements. Within hi-fi loudspeaker systems it is acceptable to allow such an adaptation procedure to take some time, since it is only necessary to perform the procedure once the loudspeaker has been moved to another position. However, in relation to telecommunication equipment, the adaptation must be continuously performed so as to be able to react to small movements of the handset relative to the ear and compensate the frequency response immediately. An audible test signal will also be unacceptable for telecommunication use, since it will disturb the telephone conversation.

Consequently, even though WO 00/22331 addresses the same principle problem of adapting the frequency response of a loudspeaker to the environments, the solution is not suited for use within telecommunication equipment.

### SUMMARY OF THE INVENTION

A possible object of the present invention may be seen as solving the problem of providing a miniature speaker unit with a frequency response independent of the acoustical load of the speaker unit. The speaker unit should not produce any audible artefacts, such as test signals, to its user compared to conventional speaker units. The speaker unit must be adapted for use in applications such as mobile phones with very limited space available.

The object is complied with by providing, in a first aspect, an electro dynamic speaker unit comprising an electro dynamic motor adapted for receiving a first electrical signal and to drive a diaphragm according to the received first electrical signal, the diaphragm being adapted to emit an acoustical output signal, sensing means adapted for generating a second electrical signal in accordance with a movement of the diaphragm, and determining means adapted for receiving the first and the second electrical signals so as to determine an acoustical load of the speaker unit from the first and the second electrical signals, and to generate a third electrical signal according to the determined acoustical load of the speaker unit.

The speaker unit may further comprise compensation means adapted to receive the first and the third electrical signal, modify the received first electrical signal in accordance with the received third electrical signal so as to compensate for the determined acoustical load of the speaker unit, and to provide the modified first electrical signal to the electro dynamic motor in order to emit a modified acoustical output signal.

The determining means may be adapted to detect movements of the diaphragm in at least a first and a second frequency band, the first frequency band being lower than the second frequency band, the determining means further being adapted to detect corresponding levels of the first electrical signal within the first and within the second frequency band.

The determining means may be adapted to determine the acoustical load of the speaker unit from a difference in sensed diaphragm movements at least at one frequency within the first and the second frequency band, and a difference in the level of the first electrical signal at least at one frequency within the first and second frequency band. The first frequency band may have an upper frequency limit below or equal to 1 kHz, and the second frequency band may have a lower frequency limit higher than 1 kHz. The first and the second frequency bands may have bandwidths of less than ⅓ of an octave relative to a centre frequency of the first and second frequency bands respectively.

The sensing means may comprise a capacitive sensor where a first plate of the capacitive sensor is formed by an electrically conductive front plate of a housing of the speaker unit, and wherein a second plate of the capacitive sensor is formed by a conductive layer on the diaphragm. The sensing means comprises a microphone.

The speaker unit may comprise a housing, the diaphragm having a back side directed inwards to the housing, and a front side of the diaphragm directed outwards from the housing, and wherein the microphone is positioned so as to sense the sound pressure within the housing. The microphone may be positioned so as to sense the sound pressure on a front side of the diaphragm. The microphone may be attached to the diaphragm. The microphone may be a silicon based microphone.

The determining means may be implemented in an ASIC. The compensation means may be implemented in an ASIC. The determining means and the compensation means may be implemented in a single ASIC. The silicon microphone may be integrated into the single ASIC. The ASIC may be attached to the diaphragm. The ASIC is attached to the back side of the diaphragm.

The sensing means may comprise a coil for detecting changes in a magnetic field generated by the electro dynamic motor driving the diaphragm.

An electro dynamic speaker unit according to the first aspect of the present invention can determine the acoustical load it is exposed to and it creates an electrical signal corresponding to the determined acoustical load. Hereby it is possible to electrically correct the input signal to the speaker unit in order to obtain a desired frequency response of the acoustical output from the speaker unit. This implies for example that change in acoustical output due to changes between a sealed and a leak acoustical condition in, for instance in telecommunication equipment, can be omitted. By applying the principles of the present invention it is possible to use a speaker which by nature has a high acoustical output impedance and still obtain an integrated speaker unit that exhibits low output impedance and thus is generally tolerant to leaks.

The object is complied with by providing, according to a second aspect, a method for active leak compensation of an electro dynamic speaker unit, the method comprising the steps of: driving a diaphragm by means of an electro dynamic motor adapted to receive a first electrical signal, the diaphragm being adapted to emit an acoustical signal, sensing a movement of the diaphragm of the speaker unit, and generating a second electrical signal in accordance with the sensed movement of the diaphragm, determining an acoustical load of the speaker unit from the first and the second electrical signals, and generating a third electrical signal in accordance with the determined acoustical load of the speaker unit.

The method may further comprise the steps of: modifying the first electrical signal in accordance with the received third electrical signal so as to compensate for the determined acoustical load of the speaker unit, and providing the modified first electrical signal to the electro dynamic motor so as to emit a modified acoustical output signal.

The determination of the acoustical load may comprise detection of movements of the diaphragm in at least a first and a second frequency band, the first frequency band being lower than the second frequency band, and detection of corresponding levels of the first electrical signal within the first and within the second frequency band. The determination of the acoustical load of the speaker unit may comprise the steps of determining a difference in sensed diaphragm movements within the first and within the second frequency band, and determining a difference in the levels of the first electrical signal within the first and within the second frequency band. The first frequency band may have an upper frequency limit below or equal to 1 kHz, and the second frequency band has a lower frequency limit higher than 1 kHz. The first and the second frequency bands may have bandwidths of less than ⅓ of an octave relative to a centre frequency of the first and second frequency bands respectively.

The sensing may comprise capacitive sensing, wherein a first plate of a capacitive sensor is formed by an electrically conducting front plate of a housing of the speaker unit, and wherein a second plate of the capacitive sensor is formed by a conductive layer on the diaphragm. A sound pressure corresponding to movements of the diaphragm may be measured using a microphone. The sound pressure may be measured within a housing of the speaker unit. The sound pressure may be measured in front of the diaphragm.

The sensing of diaphragm movements may be provided using a coil adapted to detect changes in a magnetic field generated by the electro dynamic motor driving the diaphragm.

The object is complied with by providing, in a third aspect, a mobile unit comprising an electro dynamic speaker unit according to the first aspect, the mobile unit being selected from the group consisting of: mobile phones, telephone handsets, and telephone headsets.

The object is complied with by providing, in a fourth aspect, a method for active leak compensation in a mobile unit according to the second aspect, the mobile unit being selected from the group consisting of: mobile phones, telephone handsets, and telephone headsets.

### BRIEF DESCRIPTION OF DRAWINGS

Below, the present invention is described in more details with reference to the accompanying figures, wherein

FIG. 1 shows principal diagrams illustrating the main aspects of the present invention,

FIG. 2 shows simulated sound pressure levels in an IEC 318 artificial ear for a speaker unit in a sealed condition and a leak condition (bold line),

FIG. 3 shows simulated diaphragm movement amplitudes of a speaker unit in a sealed condition and a in a leak condition (bold line) when mounted on a IEC 318 artificial ear,

FIG. 4 shows simulated sound pressure levels just in front of the diaphragm of a speaker unit in a sealed condition and a leak condition (bold line) when mounted on a IEC 318 artificial ear,

FIG. 5 shows an exploded view of a speaker unit embodiment with an ASIC attached to its diaphragm, and

FIG. 6 shows a cut away view of an assembled speaker unit with an ASIC on its diaphragm, the ASIC comprising an integrated silicon microphone.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

According to the present invention the previously described problem with intolerance to leaks can be actively compensated by applying an electrical compensation filter before applying an electrical signal to the speaker so as to essentially eliminate this change in low frequency response. An essentially flat frequency response is generally desired in all conditions in the frequency range 300-3500 Hz, such as for example demanded by the GSM standards for mobile phones.

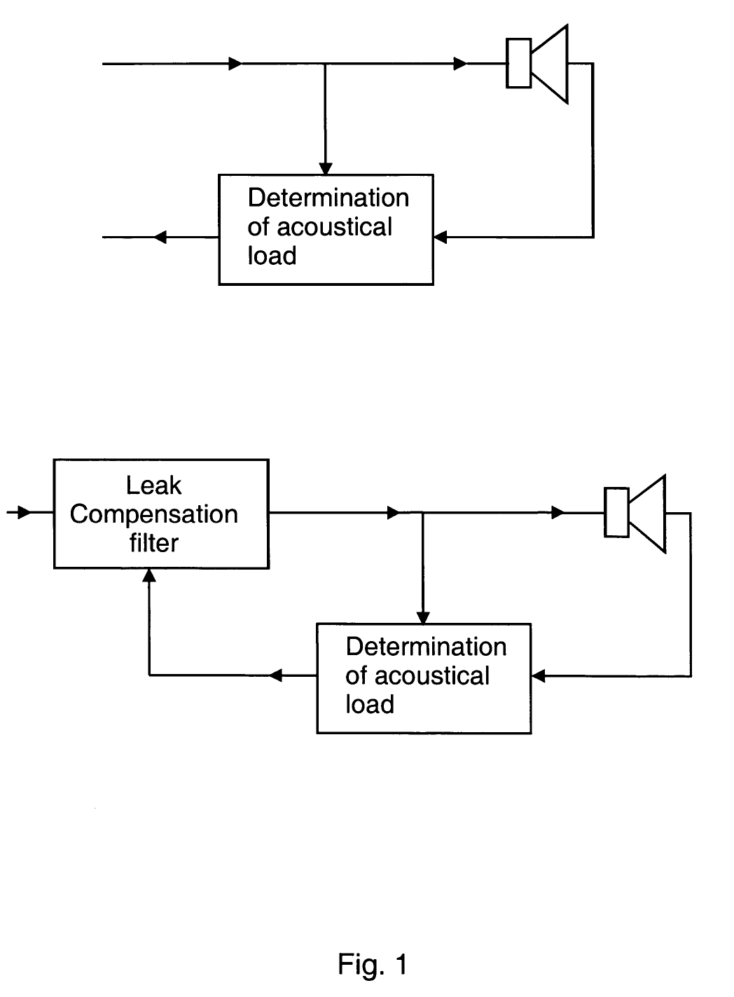

FIG. 1 illustrates the main principles according to the present invention. Upper part of FIG. 1 illustrates a speaker unit according to the first aspect of the present invention. An electrical input signal is applied to an electro dynamic motor driving a diaphragm. A resulting movement of the diaphragm is sensed and an according electrical signal and the electrical input signal is applied to means for determination of the acoustical load to which the speaker is exposed. A signal corresponding to the determined acoustical load is then provided, thus allowing a desired electrical modification of the electrical input signal according to the determined acoustical load so as to obtain a desired frequency response of the produced acoustical signal from the speaker unit.

Lower part of FIG. 1 illustrates a speaker unit according to the second aspect of the present invention. Compared to the upper part of FIG. 1 the speaker unit includes compensation means for performing a modification of the electrical signal input to the speaker unit. The electrical signal representing the determined acoustical load of the speaker unit is input to the compensation means so as to enable the applied compensation filter to reflect the acoustical load of the speaker unit. With prior knowledge of the acoustical behaviour of the speaker it is possible to apply a compensation filter so as to obtain a desired acoustical output of the speaker unit independent of the acoustical load. Hereby, it is possible to make the speaker unit tolerant to variation of the acoustical environments such as the presence of a leak between a handset and the ear of a listener.

Normally, miniature speakers for telecommunication equipment are designed so that they exhibit a flat frequency response when measured in leaky ear conditions. This implies that the same speaker will exhibit a pronounced acoustical peak in the frequency range below 500 Hz when measured in a sealed condition, such as when measured on an IEC 318 artificial ear. Therefore, a compensation filter within equipment for telecommunication use would normally include attenuation in the frequency range such as 300-1000 Hz and have neutral response above 1000 Hz. Alternatively, the compensation filter could have a neutral response in the range 300-1000 Hz and amplify the range above 1000 Hz. This way of producing a flat response in a sealed condition implies the problem of a too low level at low frequencies if there is a small leak between the mobile phone or handset and a user's ear.

The above-mentioned change in frequency response occurs because of a change in acoustical load of the speaker, i.e. the acoustical impedance applied to the speaker. Determining the exact acoustical impedance applied to the speaker is complicated and requires use of an acoustical test signal which is highly disturbing in connection with mobile equipment where it is necessary to perform a continuous detection. However, it may not be necessary to perform an exact detection of the acoustical impedance applied to the speaker. The reason is that in practice the dramatic change in frequency response from a sealed to a non-sealed condition takes place by moving the handset a few mm from the ear of the listener. Therefore, for some applications it may only be necessary to discriminate between a sealed and a leak condition and thereby providing basis for deciding between two different electrical compensation filters. For other applications requiring high sound quality it may be necessary to more precisely determine the acoustical load so as to be able to differentiate between more than two compensation filters and thus compensate the acoustical response to a higher degree of precision. It may be preferred to be able to switch between 3, 4, 5, 6, 7, 8, 9, 10 or even more filters so as to obtain a desired precision. Alternatively, a parametric filter can be implemented which may allow a more precise compensation.

For most telecommunication applications it is preferred to attenuate the frequency range below 300 Hz since this range is unimportant for transmitting speech signals and in most cases the equipment is not suited for sound reproduction in this range. Therefore, high level signals in this frequency range would tend to overload amplifiers as well as speakers thus resulting in distortion.

Electrical input signals to the speaker unit may either be an analog or a digital signal. A digital signal may be one of the following signal types: SPDIF, AES/EBU, PCM, I²S. In case it is preferred that the compensation means is placed outside the speaker unit an electrical signal representing the determined acoustical load of the speaker unit may either be provided in analog or digital form following one of the above mentioned standards.

The compensation filter means may in addition to the compensation for different acoustical load also include a filtering part for a different purpose. A general filter for equalising generic non-linearities in the speaker unit, such as caused by diaphragm resonances, may be included. Filters with other purposes may also be included, such as a bandpass filter for securing the speaker unit against large amplitudes outside its normal frequency range of operation. In addition, the compensation means may also include other types of signal processing such as signal compressing for decreasing the dynamical range of a signal with the intention of reducing distortion and saving battery power. The compensation means may also include an amplifier for amplifying a received electrical signal before providing it to the electro dynamic motor of the speaker unit. The amplifier may be an analog amplifier, such as a class A, a class B or a class AB, or it may be a digital amplifier, such as a class C or a class D amplifier.

According to the present invention the determination of the acoustical load, i.e. discriminating between a sealed and a leak condition, can be done by determining a movement amplitude of the diaphragm relative to an electrical signal applied to the speaker. To be able to determine if the speaker is applied to a sealed or a leaky condition its frequency response in both conditions must be known on beforehand. However, with this prior knowledge of the actual speaker used the discrimination procedure can be performed on a speaker unit requiring only means for detecting movement of the diaphragm and for detecting an electrical signal applied to the speaker.

The discrimination method is applicable without the presence of special acoustical test signals. An electrical signal applied to the speaker during normal use is sufficient, provided that the frequency content in the signal covers a range of at least the range 400-1000 Hz, preferably more. This can easily be obtained for example by averaging the spectral content of even a short period of normal speech.

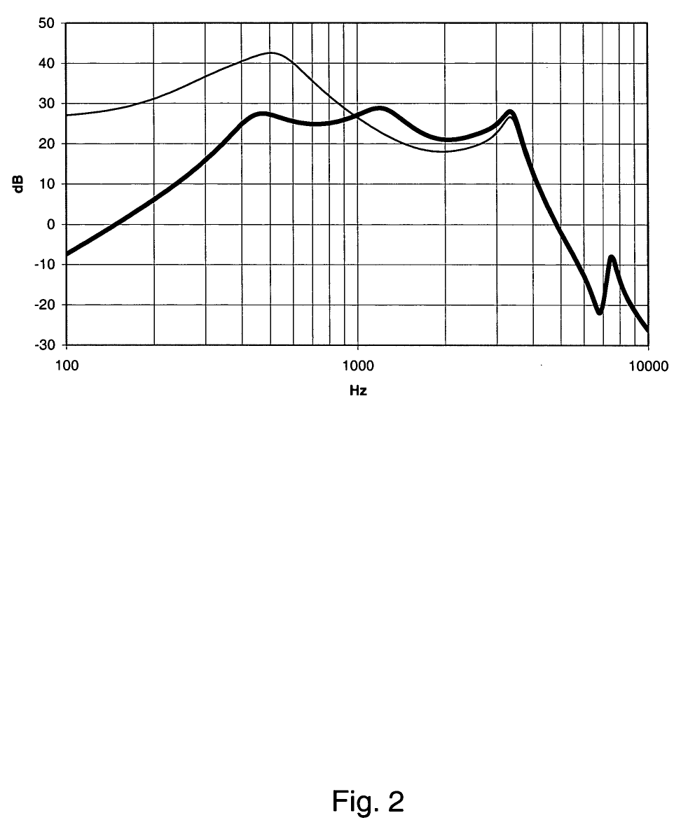

FIGS. 2-4 illustrate the principles of the invention by graphs showing various simulated parameters for a miniature speaker unit mounted in a mobile phone. The speaker unit used for the simulation is a typical high impedance speaker unit without any leak compensating means. The values shown are simulated for a sealed and a leak condition so as illustrate the behaviour of typical speaker unit in the two conditions. In both conditions it is assumed that an electrical signal with a flat spectrum was applied to the speaker unit. The sealed and leak conditions are simulated for a situation with the mobile phone mounted on an IEC 318 artificial ear according to normal standardised practice for sound measurement on telephone equipment. The simulated values should be regarded as valid in the frequency range up to approximately 3000 Hz and thus covers the frequency range up to approximately 2000 Hz which is the frequency range considered relevant with respect to leak compensation according to the present invention.

In FIGS. 2-4 the graphs show values corresponding to the sealed condition are illustrated with thin lines and the values corresponding to the leak condition are illustrated with bold lines.

FIG. 2 illustrates sound pressure level in the IEC 318 artificial ear. The spectra can thus be regarded as reflecting the sound impression that would be perceived by a human listener in the sealed and leak conditions. The difference in the spectra for the two conditions therefore also illustrates the difference that should be electrically compensated by an active leak compensation system. As seen the sound pressure level in the artificial ear is generally higher in the sealed than in the leak condition, especially at low frequencies thus corresponding to the above-mentioned perceived “loss of bass” when a handset is removed from a listener's ear. It is seen in FIG. 2 that the leak condition generally exhibits a flat spectrum in the range 300-3500 Hz, whereas the sealed condition results in a low frequency boost below 1000 Hz. Therefore, a leak compensation system should be able to attenuate this low frequency boost in the sealed condition so as to produce a generally flat spectrum in both conditions. For example a difference of more than 20 dB is seen at 300 Hz. In the frequency range 1000-3500 Hz the difference is seen to be small, e.g. less than 5 dB, and this difference is thus considered irrelevant with respect to leak compensation. Above 3500 Hz the difference between the two conditions is negligible.

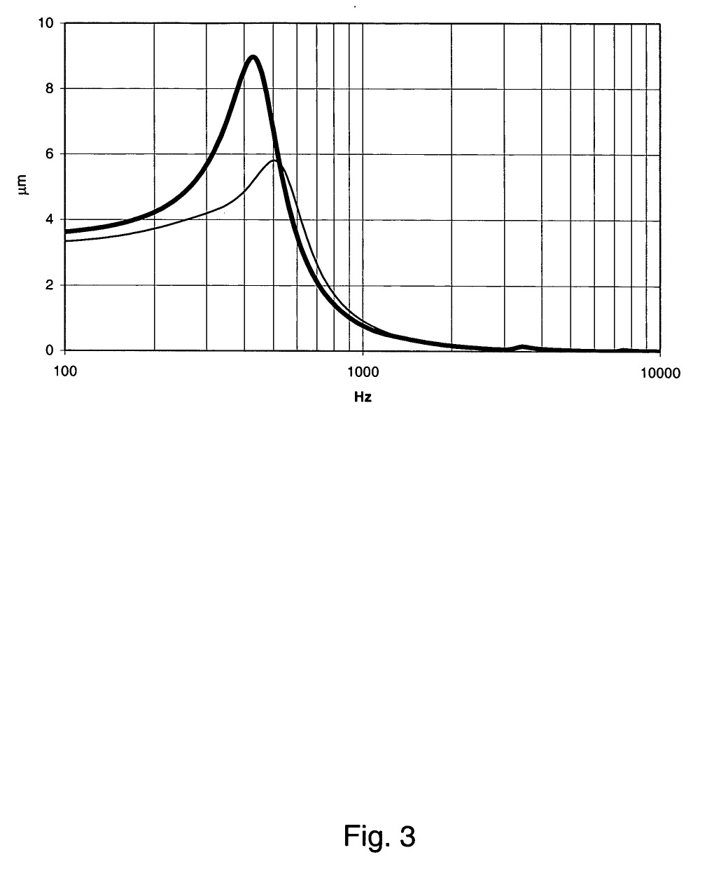

FIG. 3 shows a diaphragm movement amplitude spectrum for the miniature speaker for both sealed and leak conditions. It is evident from the two graphs that diaphragm movements exhibit significantly larger amplitudes in the leak than in the sealed condition in the frequency range below 500 Hz. Above 500 Hz the introduction of a leak does not influence the diaphragm movement amplitude significantly. The maximum diaphragm movement amplitude occurs in the frequency range 400-500 Hz. In the leak condition a maximum value of 9 μm is seen, whereas a value of less than 6 μm is seen for the sealed condition thus indicating a difference in diaphragm movement amplitude of 50%. This pronounced difference illustrates that detection of diaphragm movement amplitude is suited for discriminating between sealed and leak conditions, and it is also possible to discriminate between a number of conditions therein between so as to be able to compensate the difference in a leak compensation system.

The detection of diaphragm movement can be done in several ways. Direct detection of diaphragm movements can be performed directly with an accelerometer mounted on the diaphragm so as to produce an electrical signal proportional to an acceleration of the diaphragm. For very small transducers the extra moving mass from the accelerometer may not be acceptable. Optical detection means may also be applied to detect diaphragm movements. Using optical detection methods the diaphragm is not loaded by extra mass. However, optical methods may be too expensive for certain applications and in addition they may be too bulky.

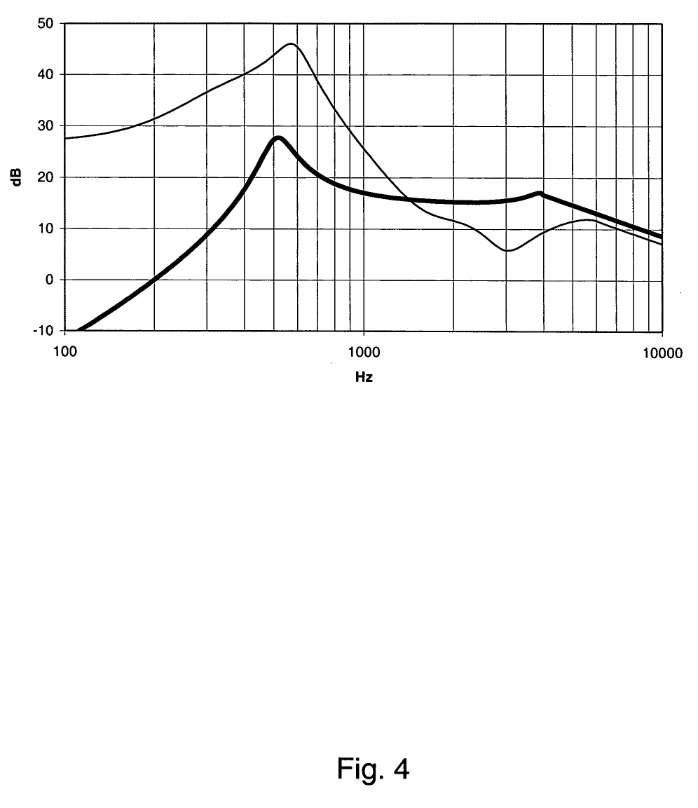

Another possible method for detecting diaphragm movement is by sensing the capacitance between two capacitor plates, wherein the diaphragm forms one of the capacitor plates, and wherein a second plate of the capacitor is formed by a stationary part of the transducer or a part of the device in which the transducer is used. For example the diaphragm can be used as part of a capacitor if an electrically conductive layer of material, such a thin layer of foil of metal, is attached to at least part of the diaphragm. This metal could for example be copper, and preferably the diaphragm could be formed by a printed circuit board such as a flexprint. A preferred second capacitor plate is a stationary part of the transducer, such as a front cover positioned in front of the diaphragm which must at least have an electrically conductive part that must be electrically isolated from the electrically conductive part of the diaphragm. Preferably, the front cover could be made of metal. Hereby, a movement of the diaphragm can be sensed by sensing the capacitance between the electrically conductive parts of the diaphragm and the protecting cover—the same principle as a capacitor microphone. The stationary part of the capacitor may be an electrically conductive foil attached to a part of the device in which the transducer is used, so that the foil is positioned in front of the diaphragm. For instance this foil may be attached to the inner side of the part of the housing of a mobile phone, the part of the housing with acoustical openings to the transducer. However, the solutions using the protecting cover as the stationary part of the capacitor may be preferred since in this way the diaphragm movement detection is integral with the transducer and it is thereby independent of the application in which the transducer is to be used. FIG. 4 shows sound pressure levels just in front of the speaker diaphragm. A generally flat spectrum with a small boost around 500 Hz is seen for the leak condition, whereas the spectrum for the sealed condition exhibits a large low frequency boost starting below 1500 Hz. Therefore, the two conditions result in significantly different spectra, especially below 1000-1500 Hz. A level difference of more than 30 dB is seen in the frequency range around 500 Hz and below 500 Hz the difference is even larger. Consequently, detection of sound pressure level in front of the speaker diaphragm is also a suited parameter for discrimination between sealed and leak conditions in order to determine which filter characteristics to use for leak compensation.

A sound pressure level in front of the diaphragm may be detected either by a microphone attached to a front side of the diaphragm, or in front of the diaphragm but close to the diaphragm. The microphone may also be mounted inside the transducer, such as attached to a back side of the diaphragm, and positioned with its sound port aligned with a small hole in the diaphragm so as to sense a sound pressure in front of the diaphragm.

Discrimination between sealed and leak conditions may also be performed by detecting a sound pressure inside the speaker unit. This can be done by means of a miniature microphone positioned within the speaker unit in a number of different ways. It can be positioned on a stationary part of the transducer, such as on the magnetic circuit, or it may be positioned on the back side of the diaphragm. If preferred the microphone may be positioned on the front side of the diaphragm with its sound port aligned with a hole in the diaphragm thus allowing the microphone to sense a sound pressure on the back side of the diaphragm, i.e. within the speaker unit.

For some applications it may be adequate to use the determined acoustical load for compensating the frequency range below 1 kHz only, since it is typically this range that primarily is influenced by variation in acoustical load, as indicated by FIG. 2. However, for applications where a more precise compensation is required it may be necessary to perform compensation in the entire frequency range, such as 300-3500 Hz within telecommunication.

For practical use there is not a suitable wide band measurement signal available for performing the discrimination procedure. With a generally unknown electrical signal applied to the speaker unit it is necessary to determine a transfer function between the electrical signal applied to the speaker unit and the preferred discrimination measure, such as sound pressure just outside the speaker unit, diaphragm movement or sound pressure within the speaker unit. The transfer function can be determined properly in a frequency range where there is enough signal level to overcome signal to noise ratio problems. However, for example within telecommunication equipment the most commonly present signal is speech. In general speech has a wide band character so it is possible to determine the mentioned transfer function with a precision that allows the desired discrimination also within an acceptably low period of averaging. The determined transfer function is then combined with prior knowledge about the behaviour of the actual speaker unit in sealed and free field conditions, and it is now possible to determine the acoustical load condition. Having determined the acoustical load current condition it is possible to select and apply a proper filtering of the electrical signal to be applied to the speaker unit so as to generally equalise the acoustical response of the speaker unit.

A proper practical method for determining the acoustical load is to determine a level of a transfer function between a sensing parameter (diaphragm movement, sound pressure in front of the diaphragm, sound pressure within the speaker) and the applied electrical signal. For example sound pressure just in front of the diaphragm may be used as sensing parameter for detecting the acoustical load of the speaker. From FIG. 4 it is shown that the detected sound pressure level in the frequency range 1500-2000 Hz may be considered as a pivot since the sound pressure in front of the diaphragm is essentially the same for the sealed and the leak conditions in this frequency range. On the contrary, in the frequency range below 1000 Hz the level difference between the two conditions is pronounced. Therefore, a discrimination task may be limited to the task of determining a difference in level of the mentioned transfer function in a first frequency band positioned in the frequency range below 1000 Hz and in a level of the transfer function in a second frequency band in the range 1500-2000 Hz. It is essential that the first frequency band should is selected such that the speaker unit exhibits a large difference between sealed and leak conditions. From FIG. 4 it is seen that a proper selection of the first frequency band could be in the frequency range below 1000 Hz, such as within the range 500-1000 Hz.

The difference in level of the transfer function between the first and second frequency band can be used to determine if the actual condition is sealed, leak or a condition in between these two conditions. As an example of the described method a second frequency band around 1500 Hz could be chosen, since from FIG. 4 it is seen that in this range the level difference is negligible. The first frequency band could be chosen around 500 Hz. If an actual level difference of 10 dB is determined in the transfer function at the first and second frequency bands it can be concluded from FIG. 4 that the actual condition is a leak condition. An actual level of 30 dB corresponds to a sealed condition. A value in the range 10-30 dB would correspond to a condition in between sealed and leak.

A proper choice of centre frequencies for the first and second frequency band should of course reflect the characteristics of the actual speaker unit. A suitable bandwidth of the first and second frequency bands may depend on a number of parameters, such as available computation power and the required signal-to-noise ratio required by the method in order to function properly. The bandwidth may be narrow bands such as 1/1-otcaves, ⅓-octaves, 1/12-octaves or even narrower.

It may be chosen to determine the level of the transfer function at more than two separate frequency bands. For example it may be chosen to calculate a level of the transfer function based on an average level determined from a number of frequency separated narrow bands below 500 Hz. The same applies for a high frequency level that may be determined based on an average of one or more narrow bands.

In practice with a not ideal measurement signal, such as speech, it may be considered an easier task to compare the determined level of the transfer function at low frequencies with a level of the transfer function determined at high frequencies. If these two levels differ less than a predetermined threshold the actual condition must be sealed, otherwise it must be a leak condition. A level difference between low and high frequencies can be determined in several ways. A simple way is to determine the total energy level of the transfer function above for example 1000 Hz and subtract from that the total energy level of the transfer function below for example 500 Hz.

Another method would be to use narrow bands for determining a high and a low frequency level. The narrow bands could have a fixed bandwidth such as 50 Hz, 100 Hz or 200 Hz. The narrow bands could also have a bandwidth relative to a centre frequency of the band such as 1/1-otcaves, ⅓-octaves, 1/12-octaves or even narrower. A low frequency level may be determined as a level of a single narrow band below 500 Hz, or it may be calculated as an average level from a number of frequency separated narrow bands below 500 Hz. The same applies for a high frequency level that may be determined based on one or more narrow bands.

With respect to the signal processing it may be preferred to use levels for one or more discrete frequencies determined by a Fourier spectrum, such as determined by a Fast Fourier Transform (FFT). A 2048, 1024, 512, 256, 128, 64 point FFT or for certain cases even FFTs with lower points such as 32 or 16 may suffice to determine a low and a high frequency level. In case an FFT spectrum has been performed a level representing low and high frequencies may be determined in different ways. A low frequency level may be determined solely form a level of a single discrete frequency below 500 Hz, or it may be determined as an average from levels at two, three or more discrete frequencies. These discrete frequencies could be either neighbour frequencies in the FFT spectrum or they could be selected so as to cover the a broader range of frequencies below 500 Hz, alternatively a combination of both methods could be used so that groups of two or more neighbour frequencies are spread in the low frequency range. Naturally, the same strategies apply for determining a high frequency level.

As described above, in a preferred embodiment, the signal processing task may be reduced to a very simple subtraction of levels determined from an FFT performed on an electrical signal received from the microphone and an FFT performed on an electrical signal applied to the speaker.

In general of course the shape of the actual transfer function for a given speaker unit may be quite different from the ones shown in FIGS. 2-4. For instance the frequency ranges where there is significant level difference between sealed and free field conditions may change according to the properties of the actual speaker. This may also be the case for the frequency range where the two conditions result in similar levels. Therefore, in general it is necessary to gain knowledge of the behaviour via measurements or calculations on the actual speaker unit in order to be able to establish the most suitable set of discrimination parameters. Among these parameters are: the low and high frequency ranges for use in the discrimination procedure, a proper threshold for deciding if a determined difference of the low and high frequency levels should be categorised as sealed or free field.

According to the present invention it is possible to integrate the acoustical load determining means into the speaker unit and then provide an electrical output signal reflecting the determined acoustical load of the speaker unit so it is possible to perform a proper compensation outside the speaker unit. This may be an advantage since it is possible to mass produce a single type of speaker unit that can be used for several applications. Some of these applications may require a very precise compensation which may require complicated signal processing means. Other applications may be able to satisfy precision requirement with more simple compensation which can be performed with a switching between two or more simple filters. For some applications it may be an advantage to perform the compensation in the device where the speaker unit is used. For example it may be an advantage to perform the compensation filtering in a mobile phone using the data processing means already present in the mobile phone. This may provide powerful data processing that enables more sophisticated filter designs. In addition to this it is possible to further reduce the size and weight of the speaker unit if the compensation means can be placed outside the speaker unit.

For some applications it is an advantage to integrate means for determining the acoustical load of the speaker and the compensation means to perform the desired compensation filtering. In this way it is possible to produce an integrated speaker unit being leak tolerant. For example this may be an advantage for applications without such as handsets or headsets.

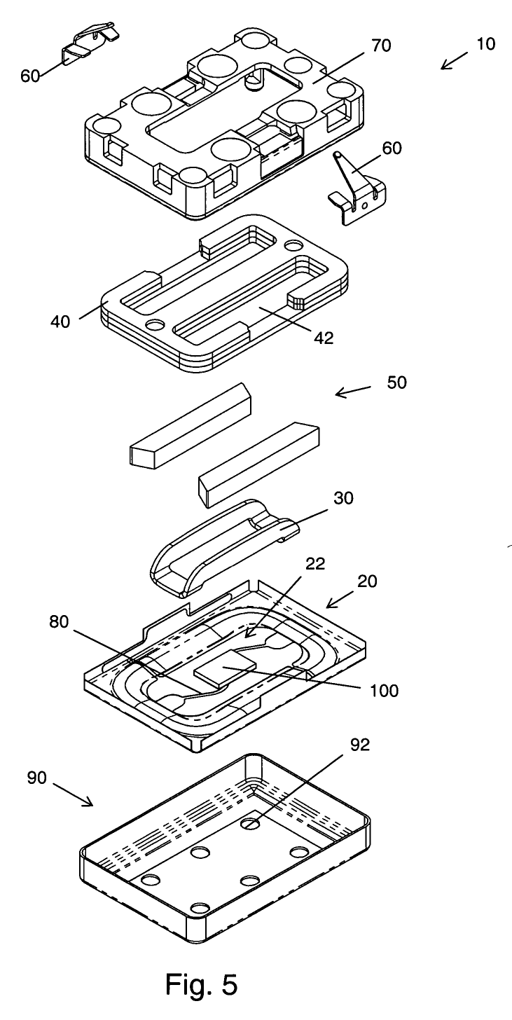

FIG. 5 show a miniature speaker unit 10 with an active leak compensation system adapted to function according to the present invention. A flat diaphragm 20 is used to generate a sound pressure. The diaphragm is formed by a printed circuit board, a flexprint. The electromagnetic motor driving the diaphragm 20 comprises a coil 30 attached to the diaphragm 20. The coil 30 has electrically conductive portions positioned in gaps of a magnetic circuit 40 with through-going holes 42. Two magnets 50 generate the magnetic field in the magnetic gaps. An ASIC 100 comprising electronic means for implementing the leak compensation system is mounted on a back side 22 of the diaphragm 20. The ASIC 100 is electrically connected to electrical conductors 80 on the back side 22 of diaphragm 20 and the chip 100 may be surface mounted so as to avoiding wires that may suffer from breaks due to fatigue. The input electrical signal to the speaker unit may be analog or digital and it may be applied to the speaker unit 10 to two external terminals 60 positioned on an outer part of a housing 70. A front cover 90 with holes 92 serves to protect the diaphragm 20 and. Movement of the diaphragm 20 is adapted to generate a sound pressure in front of the diaphragm 20 and the sound pressure will be generated externally through the holes 92 of the front cover 90.

The embodiment shown in FIG. 5 with an ASIC 100 attached to the diaphragm 20 is a general type that may be used in case of sensing diaphragm movement. For example diaphragm movements may be performed by capacitive sensing. This may be implemented by a copper layer on the diaphragm 20 forming a first plate of a capacitor and the front cover 90 forming a second plate of the capacitor. The front cover may be produced in an electrically conducting material such as a metal. Alternatively it may have a layer, such as a coating, of an electrically conducting material. The ASIC 100 may be connected to both capacitor plates and the ASIC 100 may comprise a charge amplifier to amplify an electrical signal generated by the capacitor plates according to a movement of the diaphragm. In addition, the ASIC may comprise means for processing data so as to be able to determine the acoustic condition and to select a filter accordingly so as to modify a received external electrical input signal.

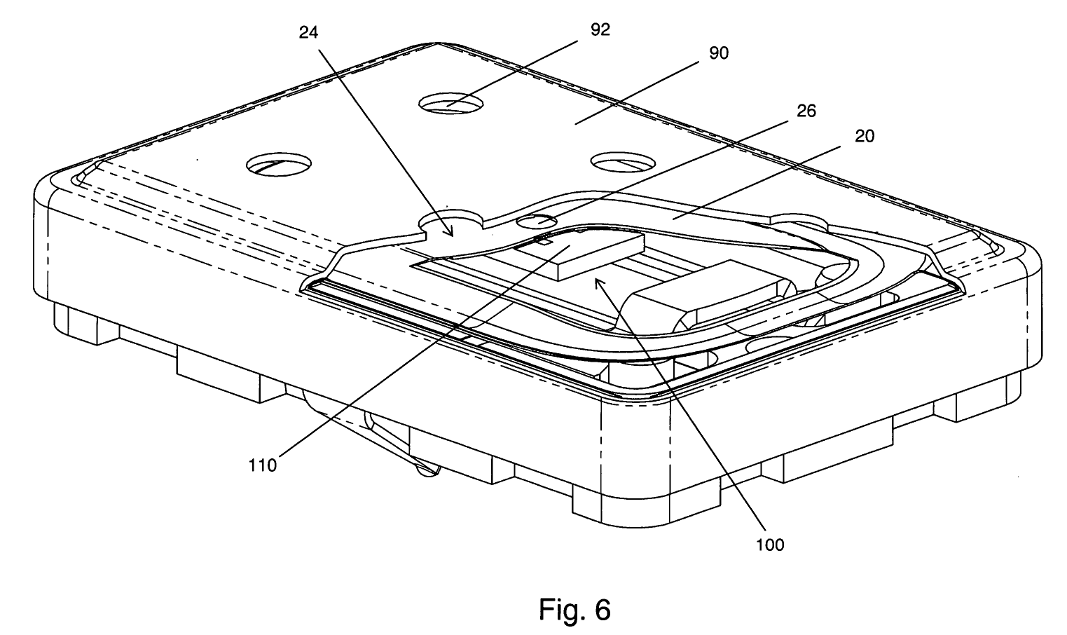

In the embodiment shown in FIG. 6 the sensing means is a miniature silicon microphone 110 being integrated with the ASIC 100 comprising all necessary electronic means to implement the active leak compensation, including a microphone preamplifier. The chip 100 comprising the silicon microphone and the electronic means is attached to a back side 22 of the diaphragm 20. The microphone part 110 of the chip 100 is positioned with its sound port opening(s) aligned with a hole 26 in the diaphragm 20 so as to be able to detect a sound pressure on the front side 24 of the diaphragm 20.

Other types of microphones than the silicon microphone shown in FIG. 6 may be used, such as for example miniature electret condenser microphones. In FIGS. 6 the microphone and all necessary electronic means are shown integrated in one chip and thereby providing a leak tolerant speaker unit that can be externally accessed either by analog or digital signals in the same way as conventional speaker units. It may be preferred that the microphone is positioned separated from the electronic means still within the speaker unit. It may also be preferred only to have a microphone positioned within the speaker unit and then having the necessary data processing performed on an external device. It may be preferred that the microphone is a digital microphone thus providing an externally accessible digital signal according to the sensed sound pressure. The digital signal may then be provided to data processing means within the application in which the speaker unit is applied, such as in a signal processing unit in a mobile phone.

The speaker units shown in FIGS. 5 and 6 can be integrated within a large variety of applications. This means that the applications become independent of the transducer with respect to special features for obtaining an acceptable leak tolerance, such as restrictions on design of acoustical openings and inner air volume etc. For example manufacturers of mobile phones can freely design the housing of a mobile phone without restrictions from the speaker unit to be used, apart from providing the necessary space in the interior of the mobile phone for the speaker unit. Design of the acoustical openings in the housing of the mobile phone become much less important by using a speaker unit which itself is generally leak tolerant.

The speakers unit shown in FIGS. 5 and 6 is well suited for applications with very limited space available. It is especially suited for applications with very small available height for the speaker unit. However, the principles according to the present invention can be applied to speaker units of many different types and sizes. The optimum improvement is obtained, as mentioned, in case of speakers that by nature have high acoustical output impedances.

1. An electro dynamic speaker unit comprising
an electro dynamic motor adapted for receiving a first electrical signal and to drive a diaphragm in accordance with the received first electrical signal, the diaphragm being adapted to emit an acoustical output signal,
sensing means adapted for generating a second electrical signal in accordance with a movement of the diaphragm, and
determining means adapted for receiving the first and the second electrical signals so as to determine an acoustical load of the speaker unit from the first and the second electrical signals, and to generate a third electrical signal in accordance with the determined acoustical load of the speaker unit.

2. An electro dynamic speaker unit according to claim 1, further comprising compensation means adapted to
receive the first and the third electrical signal,
modify the received first electrical signal in accordance with the received third electrical signal so as to compensate for the determined acoustical load of the speaker unit, and
provide the modified first electrical signal to the electro dynamic motor in order to emit a modified acoustical output signal.

3. An electro dynamic speaker unit according to claim 1, wherein the determining means is adapted to detect movements of the diaphragm in at least a first and a second frequency band, the first frequency band being lower than the second frequency band, the determining means further being adapted to detect corresponding levels of the first electrical signal within the first and within the second frequency band.

4. An electro dynamic speaker unit according to claim 3, wherein the determining means is adapted to determine the acoustical load of the speaker unit from
a difference in sensed diaphragm movements at least at one frequency within the first and the second frequency band, and
a difference in the level of the first electrical signal at least at one frequency within the first and second frequency band.

5. An electro dynamic speaker unit according to claim 4, wherein the first frequency band has an upper frequency limit below or equal to 1 kHz, and wherein the second frequency band has a lower frequency limit higher than 1 kHz.

6. An electro dynamic speaker unit according to claim 3, wherein the first and the second frequency bands have bandwidths of less than ⅓ of an octave relative to a centre frequency of the first and second frequency bands respectively.

7. An electro dynamic speaker unit according to claim 1, wherein the sensing means comprises a capacitive sensor where a first plate of the capacitive sensor is formed by an electrically conductive front plate of a housing of the speaker unit, and wherein a second plate of the capacitive sensor is formed by a conductive layer on the diaphragm.

8. An electro dynamic speaker unit according to claim 1, wherein the sensing means comprises a microphone.

9. An electro dynamic speaker unit according to claim 8, wherein the speaker unit further comprises a housing, wherein the microphone is positioned so as to sense the sound pressure within the housing.

10. An electro dynamic speaker unit according to claim 8, wherein the microphone is positioned so as to sense the sound pressure on a front side of the diaphragm.

11. An electro dynamic speaker unit according to claim 8, wherein the microphone is attached to the diaphragm.

12. An electro dynamic speaker unit according to claim 8, wherein the microphone is a silicon based microphone.

13. An electro dynamic speaker unit according to claim 1, wherein the determining means is implemented in an ASIC.

14. An electro dynamic speaker unit according to claim 1, wherein the compensation means is implemented in an ASIC.

15. An electro dynamic speaker unit according to claims 1, wherein the determining means and the compensation means are implemented in a single ASIC.

16. An electro dynamic speaker unit according to claim 12, wherein the silicon microphone is integrated into the single ASIC.

17. An electro dynamic speaker unit according to claim 13, wherein the ASIC is attached to the diaphragm.

18. An electro dynamic speaker unit according to claim 17, wherein the ASIC is attached to a back side of the diaphragm.

19. An electro dynamic speaker unit according to claim 1, wherein the sensing means comprises a coil for detecting changes in a magnetic field generated by the electro dynamic motor driving the diaphragm.

20. A method for active leak compensation of an electro dynamic speaker unit, the method comprising the steps of:
driving a diaphragm by means of an electro dynamic motor adapted to receive a first electrical signal, the diaphragm being adapted to emit an acoustical signal,
sensing a movement of the diaphragm of the speaker unit, and generating a second electrical signal in accordance with the sensed movement of the diaphragm,
determining an acoustical load of the speaker unit from the first and the second electrical signals, and
generating a third electrical signal in accordance with the determined acoustical load of the speaker unit.

21. A method according to claim 20, further comprising the steps of:
modifying the first electrical signal in accordance with the received third electrical signal so as to compensate for the determined acoustical load of the speaker unit, and
providing the modified first electrical signal to the electro dynamic motor so as to emit a modified acoustical output signal.

22. A method according to claim 20, wherein the determination of the acoustical load comprises detection of movements of the diaphragm in at least a first and a second frequency band, the first frequency band being lower than the second frequency band, and detection of corresponding levels of the first electrical signal within the first and within the second frequency band.

23. A method according to claim 22, wherein the determination of the acoustical load of the speaker unit comprises the steps of
determining a difference in sensed diaphragm movements within the first and within the second frequency band, and
determining a difference in the levels of the first electrical signal within the first and within the second frequency band.

24. A method according to claim 23, wherein the first frequency band has an upper frequency limit below or equal to 1 kHz, and the second frequency band has a lower frequency limit higher than 1 kHz.

25. A method according to claim 22, wherein the first and the second frequency bands have bandwidths of less than ⅓ of an octave relative to a centre frequency of the first and second frequency bands respectively.

26. A method according to claim 20, wherein the sensing comprises capacitive sensing, wherein a first plate of a capacitive sensor is formed by an electrically conducting front plate of a housing of the speaker unit, and wherein a second plate of the capacitive sensor is formed by a conductive layer on the diaphragm.

27. A method according to claim 20, wherein a sound pressure corresponding to movements of the diaphragm is measured using a microphone.

28. A method according to claim 27, wherein the sound pressure is measured within a housing of the speaker unit.

29. A method according to claim 27, wherein the sound pressure is measured in front of the diaphragm.

30. A method according to claim 20, wherein the sensing of diaphragm movements is provided using a coil adapted to detect changes in a magnetic field generated by the electro dynamic motor driving the diaphragm.

31. A mobile phone comprising an electro dynamic speaker unit according to claim 1.

32. A telephone handset comprising an electro dynamic speaker unit according to claim 1.

33. A telephone headset comprising an electro dynamic speaker unit according to claim 1.

34. The use of active leak compensation according to claim 20 in a mobile phone.

35. The use of active leak compensation according to claim 20 in a telephone handset.

36. The use of active leak compensation according to claim 20 in a telephone headset.
